(19) United States
(12) Patent Application Publication
(10) Pub. No.: US 2021/0031061 A1
(43) Pub. Date: Feb. 4, 2021

(54) Breathing Mask

(71) Applicant: Adam Leighton Cooper, Newmillerdam (GB)

(72) Inventor: Adam Leighton Cooper, Newmillerdam (GB)

(21) Appl. No.: 17/067,272

(22) Filed: Oct. 9, 2020

Related U.S. Application Data
(63) Continuation of application No. PCT/GB2019/050966, filed on Apr. 4, 2019.

(30) Foreign Application Priority Data
Apr. 11, 2018 (GB) 1806006.1

(51) Int. Cl. A62B 18/08; A41D 13/11

(52) U.S. Cl. CPC A62B 18/084; A41D 13/1161

(57) ABSTRACT

There is disclosed a breathing mask for sporting activities comprising an elastically stretchable portion configured to encircle a wearer's head or neck, and a filter portion attached to the stretchable portion. The filter portion is configured to cover the wearer's mouth during use. The filter portion comprises a porous, non-woven, synthetic matrix configured to retain particulates of diameter greater than 10 μm.

This invention relates to a breathing mask for use in sporting and other activities.

### BACKGROUND

Breathing masks designed to filter air prior to inhalation by a wearer are well-known. Such masks tend to be either complex, heavy and expensive (in the case of gas masks and breathing equipment for use in highly contaminated industrial areas), or very simple, lightweight and cheap (in the case of surgical masks and dust masks for use in wood- or metalworking activities). Little attention, however, has been paid to the needs of those participating in sports such as running or cycling, who may desire a mask that is relatively cheap and lightweight, but which provides more effective protection from pollutants than a typical surgical mask or woodworking mask.

US 2011/0079225 discloses a personal respiratory filtration apparatus in which a replaceable filter pad is removably incorporated in a scarf. It is disclosed that the scarf portion of the apparatus may be provided in different patterns and colours, and is intended as a fashionable item of apparel. However, the filter pad is stated to be configured to provide protection against airborne pathogens such as viruses and bacteria, and it will therefore be appreciated that the filter pad needs to be relatively dense with microscopic pores so as to prevent passage of such pathogens. Accordingly, it is considered that such an apparatus would not be accepted by runners or cyclists, since breathing would be considerably restricted.

US 2016/0316831 discloses a “fashionable versatile mask garment” in the form of a scarf or shawl incorporating a hidden filter element. The shawl or scarf has a width considerable wider than that of the filter element, and is wrapped relatively loosely around a wearer's head and held in place by way of releasable fasteners. The scarf or shawl is not disclosed as having elastic properties.

### BRIEF SUMMARY OF THE DISCLOSURE

In accordance with the present invention there is provided a breathing mask for sporting activities comprising an elastically stretchable portion configured to encircle a wearer's head or neck, and a filter portion attached to the stretchable portion, the filter portion configured as a flexible, substantially planar rectangle having a length and a width; wherein the filter portion comprises a porous, non-woven, synthetic matrix configured to retain particulates of diameter greater than 10 μm; wherein the stretchable portion comprises a band of stretchable material having first and second ends affixed to respective first and second opposed ends of the filter portion so as to form a continuous loop; wherein the stretchable portion has a width that is substantially the same as the width of the filter portion; and wherein the stretchable portion is configured to be stretchable by no more than 20% of its unstretched length and to hold the filter portion over the wearer's mouth when the stretchable portion encircles the wearer's head.

Preferably, the filter portion is configured to retain particulates of diameter greater than 5 μm.

The matrix of the filter portion may be made of a polymer material. The matrix may comprise a reticulated foam, for example an open cell reticulated foam. In one example, the matrix may be made of polyurethane foam.

Preferably, the matrix of the filter portion has a thickness no greater than 6 mm, optionally no greater than 5 mm, optionally no greater than 4 mm, optionally no greater than 3 mm, optionally no greater than 2 mm, optionally from 1 mm to 3 mm, optionally from 1 mm to 2 mm.

The filter portion may comprise just one layer of filter matrix material, or may comprise at least two layers of filter matrix material.

It has surprisingly been found that porous, non-woven, synthetic matrix industrial air filter materials of grade G4, of thickness no greater than 6 mm, optionally no greater than 5 mm, optionally no greater than 4 mm, optionally no greater than 3 mm, optionally no greater than 2 mm, optionally from 1 mm to 3 mm, optionally from 1 mm to 2 mm, are particularly effective. Grade G4 filter materials, as classified under the EN 779:2012 standard, are configured to provide an average arrestance (Aₘ) for synthetic dust of at least 90%, with a pressure drop across the filter material of no more than 250 Pa. Grade M5 filter materials may also be effective in certain embodiments. Grade M5 filter materials, under EN 779:2012, have an average efficiency (Eₘ) from 40 to 60% for 0.4 μm particles and a pressure drop no more than 450 Pa.

The EN 779:2012 standard is being replaced with the ISO 16890 standard, which classifies filter materials across four different particle size bands: coarse, 10 μm, 2.5 μm and 1 μm. It has surprisingly been found that porous, non-woven, synthetic matrix industrial air filter materials of ISO 16890 grades Coarse (ePM10<50%) or ePM10 (ePM10≥50%), of thickness no greater than 6 mm, optionally no greater than 5 mm, optionally no greater than 4 mm, optionally no greater than 3 mm, optionally no greater than 2 mm, optionally from 1 mm to 3 mm, optionally from 1 mm to 2 mm, are particularly effective.

The filter matrix may additionally comprise activated carbon and/or silver, for example by way of a coating on the matrix, so as to provide additional filtration and/or antibacterial/antiviral capability. Alternatively or in addition, the filter matrix may comprise graphene. However, it is to be understood that the material of the filter matrix used in embodiments of the present disclosure must be sufficiently porous to permit enough airflow so that athletes do not find their breathing to be substantially impaired while wearing the mask.

Because the filter matrix is made of a synthetic material, for example polyurethane foam, it will not be prone to blockage due to water condensation in the matrix from exhaled breath. This can be a particular problem for breathing masks made of natural woven materials such as cotton. However, it is possible that the retention of a small amount of moisture in the form of breath condensate within the matrix of the filter material may help to retain a higher percentage of particulate within the matrix than if the filter material is completely dry, without significantly increasing air flow resistance.

Another potential advantage of the filter matrix is that it may provide heat exchange functionality, with retained heat from exhaled air helping to warm fresh air as it is inhaled through the filter matrix.

The present Applicant has observed that some filter matrix materials as described above, for example class G4 or M5 filter materials of the preferred thicknesses, provide little or no noticeable air resistance during inhalation, but a more pronounced air resistance during exhalation. This can be beneficial for people who suffer from chronic obstructive pulmonary disease (COPD) or asthma.

The breathing mask may be configured such that the filter portion covers the wearer's mouth, but not the wearer's nose, during use. In other embodiments, the filter portion may cover both the mouth and the nose during use.

In preferred embodiments, the breathing mask is lightweight, durable and easily wearable. The breathing mask may be configured to allow conversation whilst exercising, for example by holding the filter portion relatively loosely over the mouth and lips, and by being made from materials that allow easy passage of air and thus of sound waves. These properties are desirable for athletes and individuals in urban environments.

These properties would also make the mask desirable for institutions and tower blocks where there are fire hazards.

In one embodiment, the filter matrix is provided with an outer wrapping of at least one layer of a mesh fabric. Suitable mesh fabrics include polyester mesh fabrics, nylon mesh fabrics and polyester-nylon blend mesh fabrics. Examples of such fabrics are sold under the trade marks Air-Tex®, Aertex®, Powernet, Micromesh etc. These fabrics are characterised by their light weight, low density, high porosity and soft feel against the skin. They are also relatively strong and tear-resistant, and machine washable. The air resistance of the mesh fabric should be less than the air resistance of the filter matrix. The pore size of the mesh fabric should be larger than the pore size of the filter matrix so as to allow particulate trapped by the filter matrix easily to be washed out of the filter portion when washing the breathing mask. The outer wrapping provides a soft cover for the filter matrix so as to reduce irritation of the sensitive skin around the wearer's lips and/or nose. The outer wrapping may be configured as a pocket so as to allow the filter matrix to be removed and replaced. Alternatively, the outer wrapping and the filter matrix may be secured to each other by stitching or other means. Stitching the outer wrapping to the filter matrix may help to improve the strength and wear-resistance of the filter portion. Advantageously, the outer wrapping is stitched to the filter matrix not just along edge portions thereof, but also across a middle portion of the filter matrix from one end to the other. For example, three or four or even more lines of stitching may be provided across the filter portion from one end to the other so as to hold the outer wrapping securely to the filter matrix. Alternatively or in addition, a zig-zag line or lines of stitching may be applied along the filter portion. This provides additional strength and can help reduce unwanted relative movement between the outer wrapping and the filter matrix, or unsightly bunching of the outer wrapping.

The filter portion is configured as a flexible, substantially planar rectangle. The rectangle may have a length of 5 cm to 20 cm, optionally 8 cm to 16 cm, optionally 10 cm to 14 cm. The rectangle may have a width of 2 cm to 12 cm, optionally 3 cm to 10 cm, optionally 3 cm to 6 cm, with narrower widths being more suited for embodiments in which just the mouth is covered, and wider widths being more suited for embodiments covering both the mouth and the nose. Because the filter portion is flexible, it will tend to conform to the curvature of a wearer's face when the breathing mask is worn.

The stretchable portion comprises a band made of a stretchable material and having first and second opposed ends. The first and second opposed ends are be attached to respective opposed ends of the filter portion so as to form a continuous loop. The loop is sized and shaped to fit about a wearer's head, holding the filter portion in place over the wearer's mouth and/or nose. The first and second opposed ends of the band of the stretchable portion may be stitched or otherwise permanently affixed to the respective ends of the filter portion. In embodiments where the filter matrix is wrapped in mesh fabric, and where the mesh fabric is stitched to the filter matrix, stitching the ends of the stretchable portion to the ends of the filter matrix through the mesh fabric can result in an especially strong connection.

The stretchable portion has a width that is substantially the same as the width of the filter portion. That is to say, the breathing mask comprises a continuous band or loop of substantially uniform width.

The band of stretchable material may be made of a synthetic material such as elastane or woven polyester or woven polyester blend. Synthetic materials are preferred for their good elasticity, washing and quick-drying properties.

By making the band of stretchable material substantially the same width as the filter portion, a surprising improvement in wearer comfort and fitting stability during sporting activities is achieved. This is in contrast to known breathing masks which have very narrow elastic band-type fittings that connect to a much wider filter portion covering the mouth and nose. Such known masks with narrow elastic bands can be uncomfortable due to the narrowness of the bands. Furthermore, since the known elastic bands are narrow and stretchable by significantly more than 20% of their unstretched length, they tend not to hold the filter portion securely over the mouth during sporting activities, such as running, in which a wearer's head undergoes repeated acceleration and deceleration.

The limited stretchability of the band of stretchable material is also technically significant. The stretchable portion is configured with a relatively small degree of stretch. In some embodiments, the stretchable portion may stretch by at most 10% of its unstretched length, or by at most 5% of its unstretched length. This allows the breathing mask to be held relatively tightly on the wearer's head, thus ensuring that the breathing mask stays in place while running, while still providing good comfort. The unstretched length of the stretchable portion together with the length of the filter portion defines a total closed loop circumference slightly smaller than a circumference of a wearer's head. The limited stretchability and relatively wide width (compared to prior art thin elastic bands) holds the breathing mask securely in place while still ensuring wearer comfort. A certain degree of adjustment is possible by positioning the band of stretchable material higher or lower on the back of the wearer's head, thus changing the head circumference around which the closed loop defined by the stretchable material and the filter portion fits when the mask is being worn. Furthermore, since the breathing mask of the present invention is provided in the form of a closed loop, it can easily be worn loosely and comfortably around the neck when not in use. Known breathing masks with a large mouth/nose filter and thin elastic bands cannot be worn loose around the neck while running without the large mouth/nose filter bouncing around and irritating the wearer. Moreover, the breathing mask can be removed from the wearer's head and easily double or triple wrapped around an arm or wrist, or scrunched up and kept in a pocket.

Breathing masks of embodiments of the present disclosure may be manufactured with different lengths of stretchable portion, thereby providing a good fit for differently-sized heads.

In some embodiments, the breathing mask may comprise an additional length of stretchable material, optionally made of the same material as the stretchable portion, attached to a top and/or bottom edge of the filter portion. Where the additional length of stretchable material is attached to the top edge of the filter portion, it may be selectively extended to cover a wearer's nose when the filter portion covers the wearer's mouth. This can provide additional warmth when the breathing mask is worn in cold conditions. The additional length of stretchable material may be impregnated with activated carbon, silver, silver ions, graphene or other substances so as to provide a degree of odour absorption or neutralisation. This can be useful when the wearer is passing through an area where noxious odours are present, for example near road surfacing works or sewage plants—in these situations, the wearer can choose to cover his/her nose with the additional length of stretchable material.

The various materials from which the breathing mask is made, in particular the stretchable portion and the outer wrapping, where provided, may be made in different colours and/or provided with patterns or logos or written messages. For example, breathing masks of embodiments of the present disclosure may be provided with corporate colours or logos or indicia representing a sponsor of an athletic event such as a marathon race. Alternatively or in addition, the breathing masks may be made of materials having different colours and/or patterns so as to help distinguish between different teams of athletes, for example from different countries or different athletics clubs. In other embodiments, the breathing masks may be made using fluorescent, reflective or high-visibility materials. Such embodiments may be useful in improving the visibility of a wearer to traffic, especially in low light conditions.

### BRIEF DESCRIPTION OF THE DRAWINGS

Embodiments of the invention are further described hereinafter with reference to the accompanying drawings, in which:

FIG. 1 is a schematic view of a first embodiment in a relaxed condition;

FIG. 2 is a schematic view of the first embodiment in a stretched condition;

FIG. 3 is a schematic view of the first embodiment being worn by a human wearer;

FIG. 4 is a schematic view of a second embodiment being worn by a human wearer; and

FIG. 5 is a schematic view of a filter matrix used in embodiments of the present disclosure.

### DETAILED DESCRIPTION

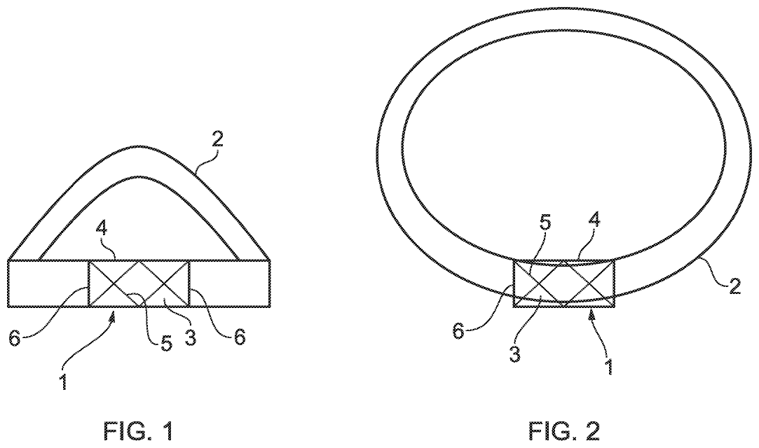

FIG. 1 shows a schematic view of a first embodiment comprising a flexible filter portion 1 and a stretchable band portion 2 in a relaxed condition. The flexible filter portion 1 is in the form of a substantially planar rectangle of porous, non-woven, synthetic filter matrix material 3 configured to retain particulates of diameter greater than 10 μm, preferably also particulates of diameter greater than 5 μm. The filter matrix material 3 is wrapped in a layer of synthetic mesh fabric 4 and attached thereto by stitching 5. The synthetic mesh fabric 4 helps to provide a softer surface for contacting the wearer's mouth and/or nose.

The stretchable band portion 2 of this embodiment is made of elastane, for example Lycra®, and ends of the band portion 2 are attached to the filter portion 1 by way of stitching 6. In this embodiment, the width of the stretchable band portion 2 and the width of the flexible filter portion 1 are substantially the same, resulting in a garment that is simple, elegant and easy to carry in a pocket or wear in a loose condition around the neck when not in use. This is in contrast to existing breathing mask designs that incorporate a bulky, rigid or semi-rigid mouth and nose filter portion that is configured to cover a wearer's chin, mouth and nose.

FIG. 2 shows the embodiment of FIG. 1 with the stretchable band portion 2 stretched to accommodate a wearer's head.

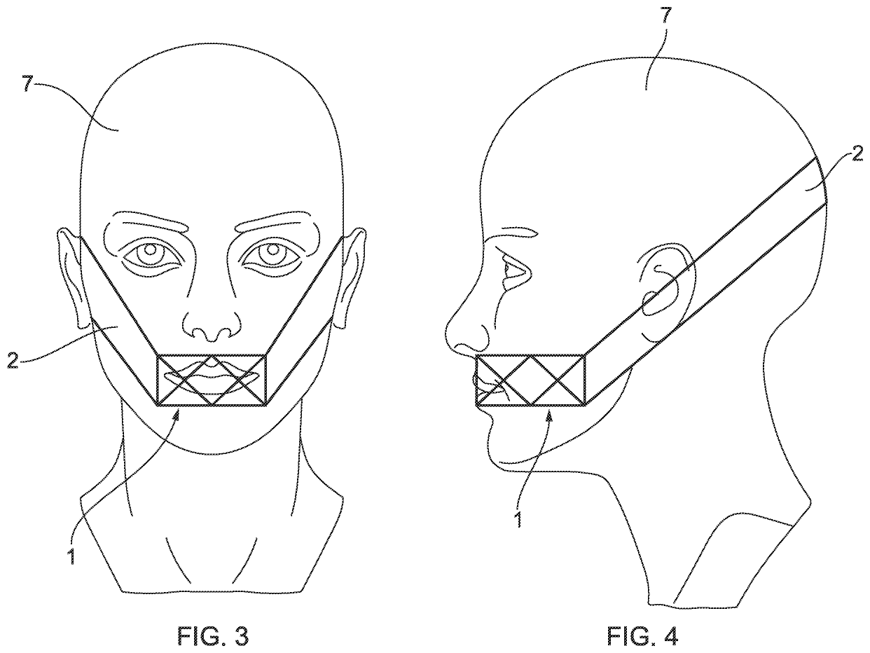

FIG. 3 is a schematic view of the first embodiment being worn by a wearer 7. The flexible filter portion 1 is held securely, yet not uncomfortably, over the wearer's mouth by way of the stretchable band portion 2, which encircles the wearer's head.

FIG. 4 shows a second embodiment being worn by a wearer 7, this time being shown from one side of the wearer's head. In the second embodiment, the flexible filter portion 1 has a greater length than that of the first embodiment.

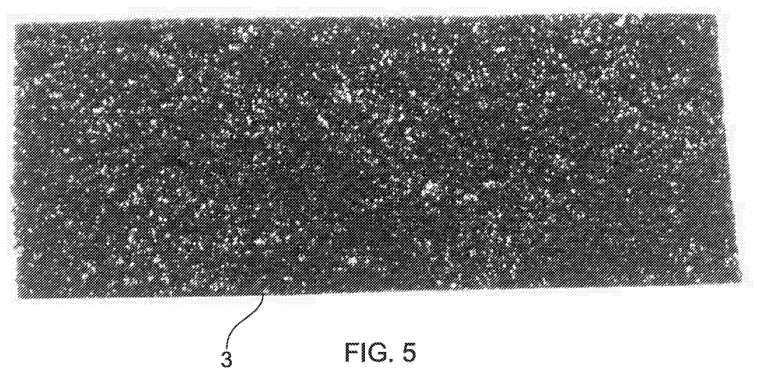

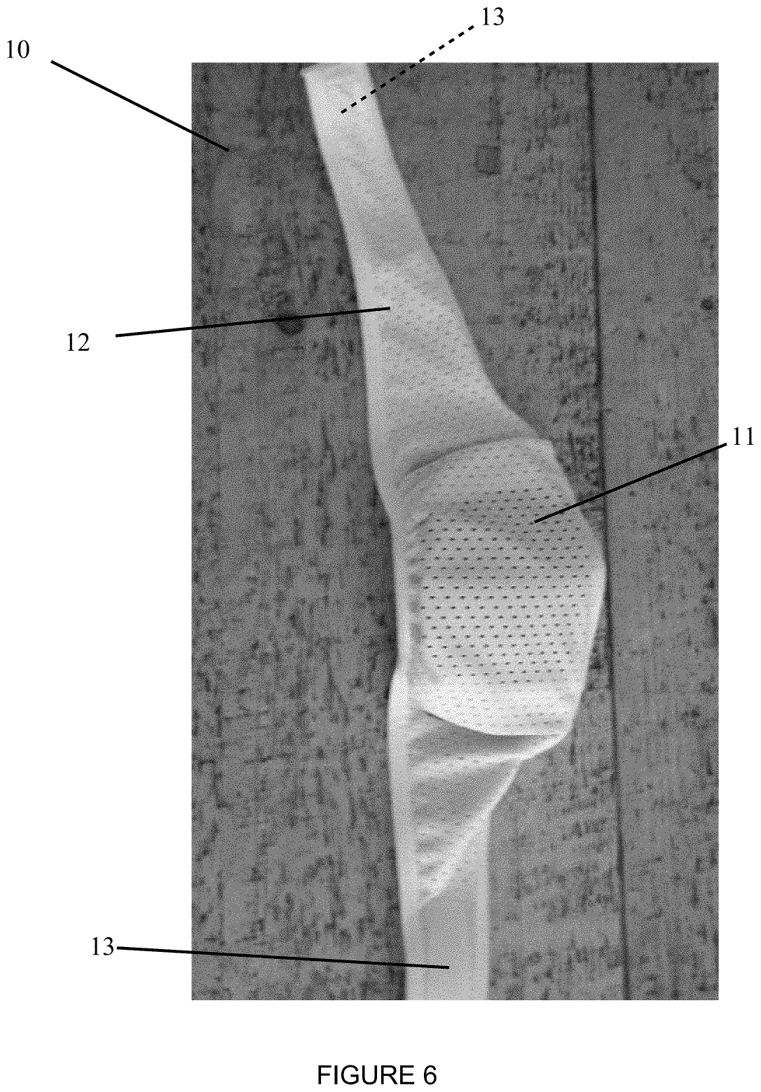

FIG. 5 shows a rectangular, porous, non-woven, synthetic matrix 3 configured to retain particulates of diameter greater than 10 μm suitable for use with embodiments of the present disclosure. The matrix has a thickness of about 1 mm, although other thicknesses may be useful. The matrix may have a length of around 12 cm and a width of around 5 cm, although other lengths and widths may be useful. It can be seen that the matrix material 3 is porous, with a pore size chosen to comply with class G4 or M5 filtration standards under EN 779:2012.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A breathing mask for sporting activities comprising an elastically stretchable portion configured to encircle a wearer's head or neck, and a filter portion attached to the stretchable portion, the filter portion configured as a flexible, substantially planar rectangle having a length and a width; wherein the filter portion comprises a porous, non-woven, synthetic matrix configured to retain particulates of diameter greater than 10 μm; wherein the stretchable portion comprises a band of stretchable material having first and second ends affixed to respective first and second opposed ends of the filter portion so as to form a continuous loop; wherein the stretchable portion has a width that is substantially the same as the width of the filter portion; and wherein the stretchable portion is configured to be stretchable by no more than 20% of its unstretched length and to hold the filter portion over the wearer's mouth when the stretchable portion encircles the wearer's head.

2. A breathing mask as claimed in claim 1, wherein the elastically stretchable portion is made of a synthetic material, optionally elastane or woven polyester or woven polyester blend.

3. A breathing mask as claimed in claim 1 or 2, wherein the stretchable portion is configured to be stretchable by no more than 10% of its unstretched length, optionally by no more than 5% of its unstretched length.

4. A breathing mask as claimed in any preceding claim, wherein the filter portion is configured to retain particles of diameter greater than 5 μm.

5. A breathing mask as claimed in any preceding claim, wherein the filter matrix is made of reticulated foam.

6. A breathing mask as claimed in claim 5, wherein the filter matrix is an open cell reticulated foam.

7. A breathing mask as claimed in claim 5 or 6, wherein the filter matrix is a polyurethane foam.

8. A breathing mask as claimed in any preceding claim, wherein the filter matrix has a thickness no greater than 6 mm, optionally no greater than 5 mm, optionally no greater than 3 mm, optionally no greater than 2 mm, optionally from 1 mm to 3 mm, optionally from 1 mm to 2 mm.

9. A breathing mask as claimed in any preceding claim, wherein the filter portion comprises at least two layers of filter matrix.

10. A breathing mask as claimed in any preceding claim, wherein the filter matrix comprises an air filter material of grade G4 under EN 779:2012.

11. A breathing mask as claimed in any one of claims 1 to 9, wherein the filter matrix comprises an air filter material of grade M5 under EN 779:2012.

12. A breathing mask as claimed in any one of claims 1 to 9, wherein the filter matrix comprises an air filter material of ISO 16890 grade Coarse (ePM10<50%).

13. A breathing mask as claimed in any one of claims 1 to 9, wherein the filter matrix comprises an air filter material of ISO 16890 grade ePM10 (ePM10≥50%).

14. A breathing mask as claimed in any preceding claim, wherein the filter matrix additionally comprises at least one of: activated carbon, silver, silver ions and/or graphene.

15. A breathing mask as claimed in any preceding claim, wherein the filter matrix is provided with an outer wrapping of at least one layer of a mesh fabric.

16. A breathing mask as claimed in claim 15, wherein the mesh fabric is a synthetic mesh fabric.

17. A breathing mask as claimed in claim 16, wherein the mesh fabric is selected from the group consisting of: polyester mesh fabrics, nylon mesh fabrics and polyester-nylon blend mesh fabrics.

18. A breathing mask as claimed in any one of claims 15 to 17, wherein the mesh fabric and the filter matrix are stitched together to form the filter portion.

19. A breathing mask as claimed in claim 18, wherein the mesh fabric and the filter matrix are stitched together across a central area of the filter portion.

20. A breathing mask as claimed in any preceding claim, wherein either or both of the filter portion and the stretchable portion comprise at least one material selected from the group consisting of: fluorescent material, reflective material, high visibility material, patterned material, coloured material and material bearing logos or other indicia.

21. A breathing mask as claimed in any preceding claim, wherein the filter portion is sized and shaped to cover a wearer's mouth but not the wearer's nose.

22. A breathing mask as claimed in any preceding claim, further comprising an additional length of stretchable material secured to a top edge of the filter portion, the additional length of stretchable material being configured for selective deployment to cover a wearer's nose.

23. A breathing mask as claimed in claim 22, wherein the additional length of stretchable material is impregnated with at least one component selected from the group consisting of activated carbon, silver, silver ions, graphene and odour-neutralising compounds.

24. A breathing mask as claimed in any one of claims 1 to 20, wherein the filter portion is sized and shaped to cover a wearer's mouth and nose at the same time.

25. A breathing mask as claimed in any preceding claim, wherein the width of the filter portion and the stretchable portion is from 2 cm to 12 cm, optionally from 3 cm to 10 cm, optionally from 3 cm to 6 cm.

26. A breathing mask as claimed in any preceding claim, wherein the length of the filter portion is from 5 cm to 20 cm, optionally from 8 cm to 16 cm, optionally from 10 cm to 14 cm.

27. The breathing mask of any preceding claim in which the stretchable portion has a width that is less than the width of the filter portion.

28. The breathing mask of any preceding claim in which the stretchable portion is adjustable.

29. A breathing mask for sporting activities comprising an elastically stretchable portion configured to encircle a wearer's head or neck, and a filter portion attached to the stretchable portion, the filter portion configured as a flexible, substantially planar rectangle having a length and a width; wherein the filter portion comprises a porous, non-woven, synthetic matrix configured to retain particulates of diameter greater than 10 μm; wherein the stretchable portion comprises one or more bands of stretchable material affixed to respective first and second opposed ends of the filter portion; and wherein the stretchable portion is configured to be stretchable by no more than 20% of its unstretched length and to hold the filter portion over the wearer's mouth when the stretchable portion encircles the wearer's head.

30. A breathing mask for sporting activities comprising an elastically stretchable portion configured to encircle a wearer's head or neck, and a filter portion attached to the stretchable portion, the filter portion configured as a flexible, substantially planar rectangle having a length and a width; wherein the filter portion comprises a porous, non-woven, synthetic matrix configured to retain particulates of diameter greater than 10 μm; wherein the stretchable portion comprises two or more bands of stretchable material affixed to respective first and second opposed ends of the filter portion; wherein the stretchable portion is adjustable; and wherein the stretchable portion is configured to be stretchable by no more than 20% of its unstretched length and to hold the filter portion over the wearer's mouth when the stretchable portion encircles the wearer's head.

31. The breathing mask of claim 28 or 30 wherein the adjustable stretchable portion incorporates hook-and-loop (Velcro®) type portions for mutual and adjustable attachment.

32. The invention(s) as shown and substantially described herein.
